(19) United States
(12) Patent Application Publication
(10) Pub. No.: US 2006/0161968 A1
(43) Pub. Date: Jul. 20, 2006

(54) Method and apparatus for secure delivery and evaluation of prototype software over a network

(75) Inventors: Robert T. Crombie, Maple Valley, WA (US); Patrick J. Link, Carnation, WA (US); Ben V. Ong, Seattle, WA (US); David McCarten, Bothell, WA (US)

Correspondence Address: NIXON & VANDERHYE, PC, 901 NORTH GLEBE ROAD, 11TH FLOOR, ARLINGTON, VA, 22203, US

(73) Assignee: Nintendo Co., Ltd., Kyoto-fu (JP)

(21) Appl. No.: 11/312,652

(22) Filed: Dec. 21, 2005

Related U.S. Application Data
(60) Provisional application No. 60/637,659, filed on Dec. 21, 2004.

(51) Int. Cl. H04L 9/32

(52) U.S. Cl. 726/2

(57) ABSTRACT

Prototype software is securely delivered and evaluated by electronic transfer over a network. The software is secured by multiple levels of encryption to prevent unauthorized copying, modification, and/or use of the prototype software. Electronic transfer of the prototype software minimizes the time and cost associated with providing prototype software for testing to remote third party testers. Once the software has been transferred electronically to the third party tester, the software developer electronically maintains control of that software by restricting access to an authorized third party, monitoring testing, and deleting any files related to the prototype software from the third party test workstation.

### RELATED APPLICATIONS

This application claims priority from the commonly-assigned U.S. provisional patent application Serial No. 60/637,659, filed on Dec. 21, 2004, the contents of which are incorporated here by reference.

This application is also related to the following co-pending commonly-assigned patent application Ser. No. 10/293,943 of Sloate et al. entitled, “MULTIPLEXED SECURE VIDEO GAME PLAY DISTRIBUTION.”

### TECHNICAL FIELD

The technology described relates to testing prototype software, and more particularly, to secure electronic delivery and evaluation of prototype software distributed over a network to third parties. One non-limiting example application is to testing and evaluating prototype game software.

### BACKGROUND

Traditionally, software is used on “local” hardware. Consider video game software. A video game is typically purchased for use with a home video game system such as the Nintendo GameCube system or a home personal computer (PC). Home is a general term used as a contrast to playing a game at an arcade. To play a game, the user usually selects a video game on optical disk or other storage device and then controls the “local” hardware to begin executing the game. The game is then displayed on the user's television set, personal computer display, or a handheld computer display. But there are instances where software needs to be used on “remote” hardware. One such instance may occur during the software development.

Before software is provided in its final form to end-users, it goes through a development, testing, and evaluation process. As the software moves through various stages of the process, it is oftentimes desirable to send that software to parties other than the developers to execute and experience (hereafter “third parties”). Those third parties, which may be part of the software development organization or outside of it, then test and/or evaluate the software. They often make suggestions to the software developers and/or marketers to help improve the software's performance and/or appeal. Although it is possible to bring such third parties to the physical plant of the software developer and carefully control the conditions under which third parties evaluate the prototype software, it may be more convenient and efficient to have third parties test prototype software away from the developer's physical plant.

But testing outside the developer's physical plant raises security issues regarding the software. Most important is how to prevent illegal copying when the software is distributed electronically, when it is being tested, and when testing is complete. One security approach is to load the prototype software into a secure “lock box,” and have a developer employee physically deliver the prototype software to the third party evaluator. The delivery person must monitor its use, and when the third party evaluator is done, make sure that no copies were made and that the lock box copy is securely returned to the software developer. The time and expense associated with this approach are significant. Moreover, there is always a risk that the prototype software may be lost, stolen, or otherwise misappropriated despite precautions and preventive efforts.

### SUMMARY

The technology described below overcomes these problems. The technology securely delivers software over a network to an evaluation site and monitors the evaluation of the software at the delivered site also via the network. In one example application, the software is prototype software to be tested by a third party different from a developer of the prototype software. One example prototype software is game software. The software is encrypted using one or more levels of encryption (preferably at least two). The encrypted software is transmitted from a server over the network to a client at the evaluation site for execution of the software to permit the evaluation of the software. But before the software can be executed, the client is initially authenticated by the server over the network. If the authentication is positive, the server authorizes execution of the software at the client. The server monitors the evaluation during the execution of the software at the client and determines whether the evaluation should be halted. The monitoring by the server prevents unauthorized use of the prototype software at the client.

If the evaluation is halted, the server prohibits execution of the software or access to the software at the client. For example, the server may, via its control of the software at the client via the network, erase the prototype software from the client machine. The server may also prevent transmission, copying, or modification of the software at the client.

The server may halt the evaluation for other reasons. For example, the client may be given only a certain time period or window during which the evaluation may be conducted. The server starts a check out period associated with when the server transmitted the software over the network to the client, monitors the check out period, and prohibits further execution of the software or access to the software at the client when the check out period expires.

The monitoring may include the server periodically prompting the client to provide the server with some information, If the client fails to provide the prompted information within a predetermined time period, then the server prohibits execution of the software or access to the software at the client. The initial authentication may include requiring the client to provide the server a correct log-in identifier and a correct password.

The client electronically receives the software via the network. Assuming the software is encrypted on at least two encryption levels, the client decrypts the software at one of the encryption levels and stores the decrypted software. The client initially performs authentication over the network with the server. For example, the client may have to provide the server with a correct log-in identifier and a correct password. If the authentication is positive, the software is temporarily stored at the client machine. Preferably, the software is temporarily stored in a password-protected hard disk drive that renders contents stored on the hard disk drive inaccessible to the evaluator. If the authentication is positive, the client is also permitted to decrypt a first portion of the software at the other of the encryption levels and executes the first software portion to permit evaluation of the first software portion. After decrypting the first portion and before execution of the first software portion is completed, the client decrypts a second portion of the software at the other of the encryption levels and executing of the second software portion to permit evaluation of the first software portion. This on-the-fly decryption of the software to be next executed is advantageous both in terms of security and in terms of efficient software execution.

During the decrypting and executing, the client receives over the network multiple prompts from the server. The client responds to the prompts to ensure continued execution and evaluation of the software at the client. Access to and execution of the software is controlled by the server. Control signals from the server over the network prevent unauthorized use of the prototype software at or by the evaluator including preventing transmission, copying, or modification of the prototype software.

### BRIEF DESCRIPTION OF THE FIGURES

FIG. 1 is function block diagram illustrating one non-limiting example of a system for securely delivering and monitoring evaluation of prototype software over a network;

FIG. 2 is a flowchart illustrating non-limiting example procedures for securely delivering and monitoring evaluation of prototype software over a network;

FIG. 3 is function block diagram illustrating another non-limiting example of a system for securely delivering and monitoring evaluation of prototype software over a network; and

FIG. 4 is function block diagram illustrating another non-limiting example of a system for securely delivering and monitoring evaluation of prototype game software over a network.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), field programmable gate arrays, one or more digital signal processors (DSPs), etc.

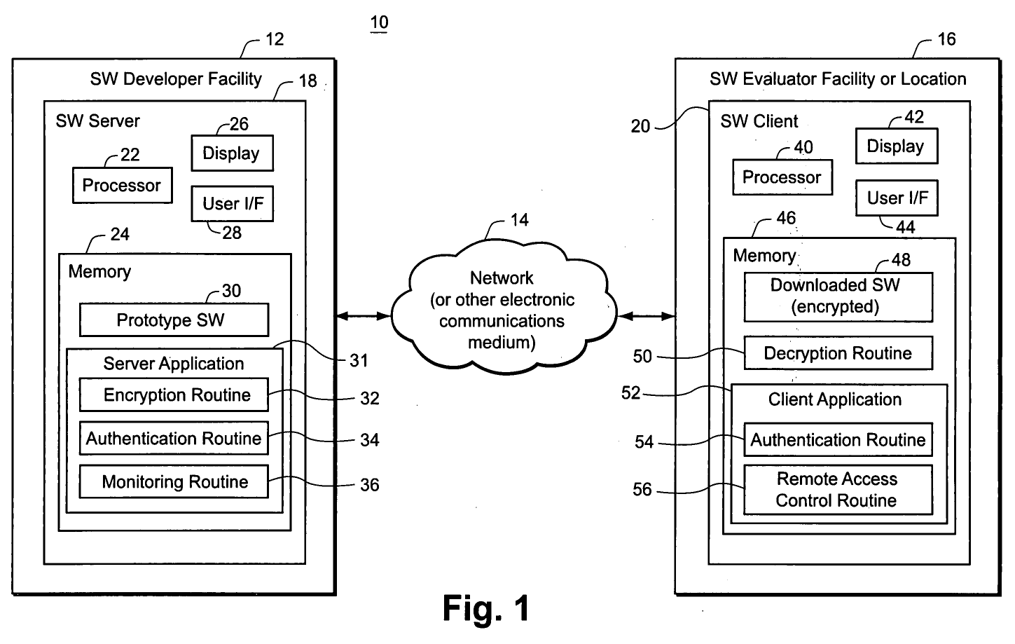

Reference is now made to FIG. 1 which illustrates an example software (SW) evaluation system 10 which includes a software (SW) developer facility or location 12 coupled to a software (SW) evaluator facility or location 16 via a network 14 (or some other electronic communications medium). The software developer facility 12 and the software evaluator facility 16 may or may not be within the control of the software developer. In other words, the software client 20 may be an in-house evaluator and the network 14 may be a private local area network (LAN). The term client includes a machine, a software entity or program, etc. On the other hand, the software evaluator might not be under the control of the software developer 12. In that case, the network 14 might be a public communications network such as the Internet.

The software developer facility 12 includes a software server computer 18 that includes a data processor 22, a memory 24, a display 26, and a user interface 28. The memory 24 stores prototype software 30 to be evaluated and a server application 31 for remote testing of prototype software including an encryption routine 32, an authentication routine 34, and a monitoring routine 36.

The encryption routine may include one or more proprietary and/or publicly known encryption algorithms. In a preferred example embodiment, the prototype software 30 is distributed over the network in a multi-level encrypted format. For example, the software 30 may be encrypted with a first encryption layer and a second encryption layer. The second encryption layer is used for added protection while the software is electronically distributed over the network 14. Each encryption layer preferably uses different encryption algorithms, although the same encryption algorithm could be used but with different parameters at each layer, e.g., different encryption keys, passwords, etc.

Once the prototype software has been successfully transferred to the remote software facility 16, the second encryption layer may be removed by the software client 20 leaving the first encryption to protect the software program during storage at the client. Multiple encryption layers ensures a very high level of security for the prototype software when it is most likely to be intercepted by an unauthorized party during network transmission. Once physically temporarily stored at the third party station, the prototype software is less prone to rogue attack. Removing one or more extra encryption layers before storage permits faster execution of that prototype software at the third party client. By removing one encryption layer before storage, the prototype software can be executed more quickly, and as a result, tested more efficiently. The second encryption level could be, for example, public-private key cryptography with the SW server and client processors being provided with the necessary keys. Consequently, the software remains encrypted even after arrival and temporary storage at the client 20 to protect it against attack while stored at the client 20. Greater security may be provided by adding further encryption levels, if desired.

The authentication routine 34 authenticates a software client user (the software evaluator) and performs log-in identification, password verification, and then an on-going authentication dialog between the software server 18 and the software client 20. The initial authentication must be successfully completed in order for the software to be temporarily stored by or at the client machine. If that authentication dialog is broken prematurely or is not conducted in accordance with the authentication protocol, the monitoring routine 36 in the server application 31 prevents the client application 52 from executing the prototype software. To resume execution, the user must perform some type of re-authorization process, e.g., repeat the log-in authentication procedure.

The software client 20 includes a processor 40, display 42, a user interface 44, and a memory 46 for storing the electronically-transferred prototype software 30, preferably in encrypted format at 48. In a preferred example embodiment, the processor 40 employs a decryption routine 50 to remove a top level of encryption before storing the software 38 in the memory 46. The client application 52 includes an authentication routine 54 for communicating using the required protocol with the server's authentication routine 34. The client application 52 also includes a remote access control routine 56 which gives the server application 31 remote control over the client 20 for the testing process until the client 20 no longer can access the prototype software. This control ensures only authorized users test the prototype software and only authorized use is made of the prototype software. The remote control prevents unauthorized use such as copying, modifying, or electronically distributing prototype software.

Once the software client 20 has properly logged on and been authenticated by the server application 31, the server application 31 enables the client processor 40, via the remote access routine 56, to access the prototype software 48 stored in the memory 46. Assuming the prototype software 48 is stored in decrypted form, the client is provided by the processor 40 with the appropriate decryption tools to decrypt the prototype software for execution on-the-fly. On-the-fly decryption is preferred because it provides an extra level of security where only the specific software needed for immediate execution is available, while the remainder of the prototype software remains encrypted. On-the-fly decryption is also advantageous because the tester does not need to wait for the longer time that it takes for the entire prototype software to be decrypted. Alternatively, a hardware board or other device may be provided to the SW evaluator 16 and coupled to the client machine so as to perform the decryption. The SW evaluator 16 then is free to execute the prototype software for testing and evaluation.

The security monitoring routine 36 at the SW developer facility 12 establishes a testing time period during which the SW client 20 is authorized to evaluate the prototype software. Once that time has expired, the security monitoring routine 36 halts further execution of the prototype software at the SW client 20 and erases that software from the memory 46 via the remote access control routine. The security monitoring routine 36 may perform other operations like searching the client memory 46 for unauthorized files and either erasing them or notifying the software developer.

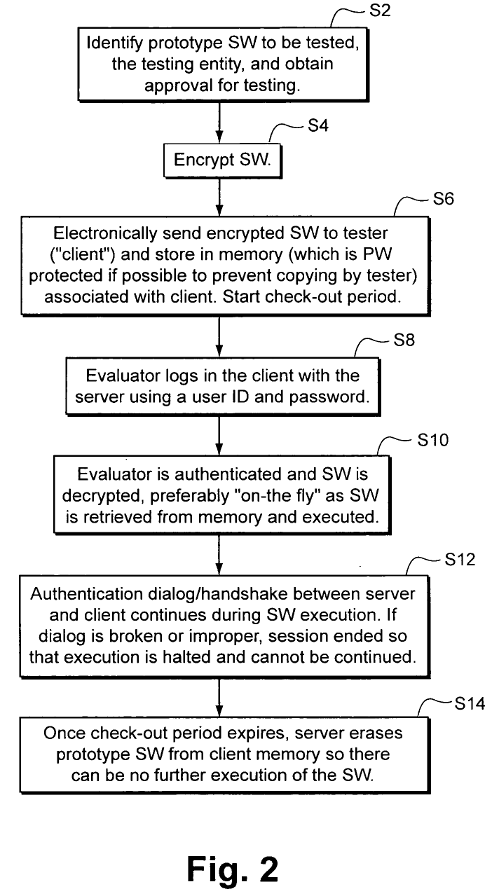

Reference is now made to the flow chart diagram in FIG. 2 illustrating example procedures for carrying out a method in accordance with one illustrative embodiment. Initially, an authorized person at the software developer facility 12 identifies prototype software to be tested along with the testing or evaluating entity, and obtains approval before distributing the prototype software for evaluation or other testing (step S2). The prototype software, if not already encrypted, is encrypted using one or more layers of proprietary and/or public encryption algorithms (preferably multiple layers) (step S4). The encrypted software is then sent electronically, e.g., over some sort of network, to a client where the encrypted software is stored in memory 48. While the client could be run on a common personal computer (PC) or the like, the client may also be implemented using a special testing machine to increase security. After removing at least a first encryption layer in the preferred embodiment, the stored prototype software may, in some implementations such as those described later, be password protected to further prevent unauthorized copying. A “check-out” time period is started by the monitoring routine 36 (step S6). The third party evaluator interacts with the software client 20 via the display and user interface to log-in with the software server via the network using, for example, a log-in ID and a log-in password (step S8). The server application 18 authenticates the evaluator, and instructs the client processor 40 to decrypt on-the-fly the encrypted prototype software being retrieved from memory 48 and then execute the prototype software (step S10).

As the prototype software is executed on the software client, an authentication dialog is maintained between the server and the client. If that dialog is broken or is otherwise improper, the server disables the client from further execution of the prototype software (step S12). Once the check out period expires, the server erases the prototype software from the client memory and disables any further execution of that prototype software at the client (step S14).

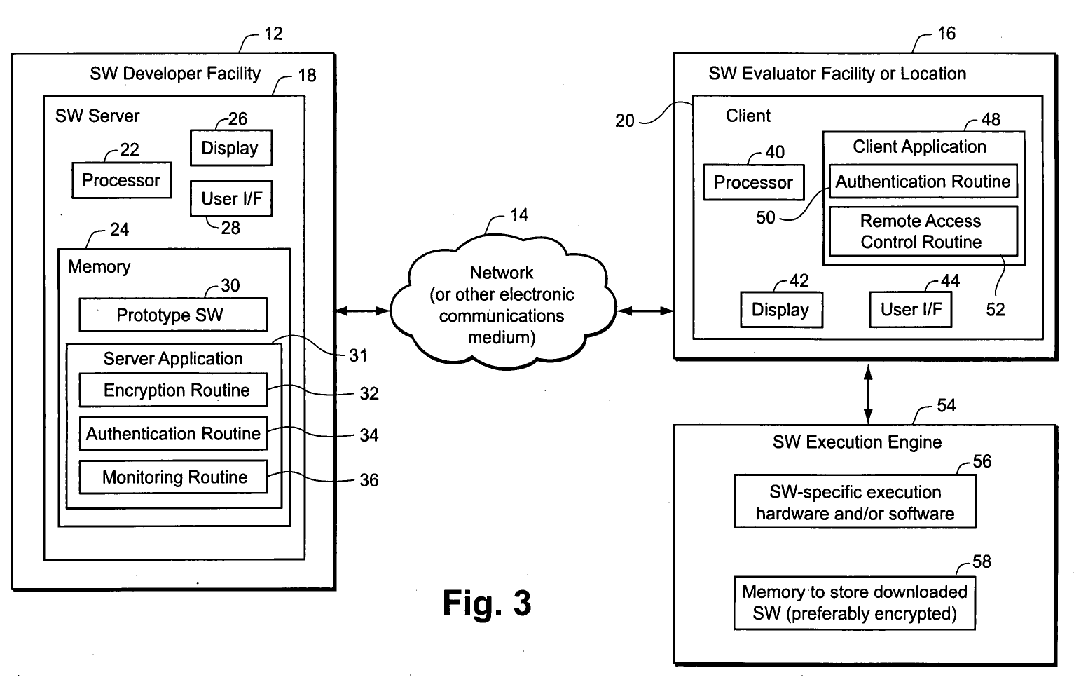

FIG. 3 illustrates another non-limiting example software evaluation system similar to that shown in FIG. 1. But in this embodiment, the client works in conjunction with a software execution engine 54 that includes hardware and/or software 56 that is specifically configured to execute the prototype software. The software execution engine 54 also includes a memory 58 (such as a hard disk drive) to store the prototype software (preferably encrypted) received via the network 14 and the client 20 from the software server 18. The software execution engine 54 may be integrated with the client machine 20 or may be coupled to the client machine 20. Such an execution engine 54 may be necessary or useful for specialized or otherwise proprietary prototype software execution. Moreover, the software execution engine 54 permits additional security. For example, if memory 58 is a hard drive, it may be password protected using an advanced technology attachment (ATA)-based password. Such password protection is typically not readily implemented for the hard drive of the client 20.

In this example embodiment, the client 20 stores the client application 48, which includes an authentication routine 50, to perform log-on and then handshake communications with the server authentication routine 34 during the time when the prototype software is being executed by the software evaluator. In addition, the client application 48 includes a remote access control routine 52 that permits the monitoring routine 56 in the software server 18 to control the client machine 20 at least with respect to its handling of the prototype software. Once the test period expires or there has been some other event, the monitoring routine 36 erases the prototype software from the memory 58 via the remote access control routine 52.

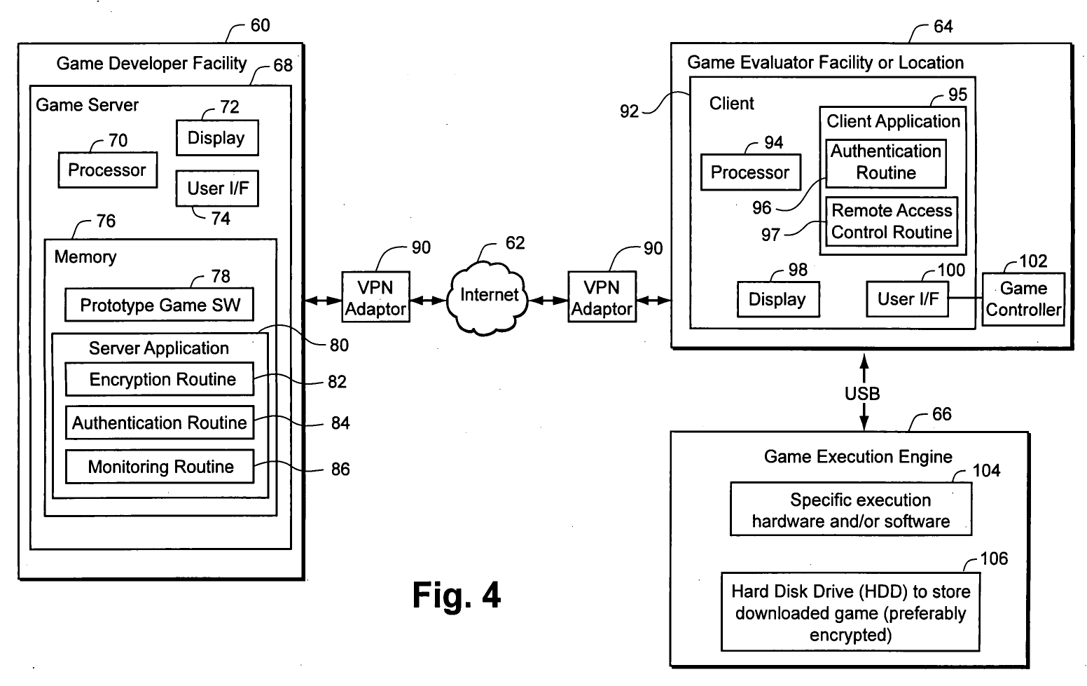

FIG. 4 shows another example non-limiting embodiment applied to video games. A video game developer facility 60 includes a game server 68 coupled via the Internet 62 to a game evaluator facility or location 64. Access to the Internet by the server 68 and the client 92 may be for example, by way of respective virtual private network (VPN) adaptor 90. The game evaluator facility 64 is coupled via a USB link to a game execution engine 66. The game server 68 includes a processor 70, a display 72, a user interface 74, and a memory 76. The memory 76 includes prototype game software 78 to be evaluated by the game evaluator. The memory 76 also includes a server application 80 with an encryption routine 81, an authentication routine 82, and a monitoring routine 88.

The client 92 includes a processor 94, a client application 95 which includes an authentication routine 96 and a remote access control routine 97, a display, a user interface, coupled to a game controller 102. The game execution engine 66 includes game-specific execution hardware and/or software 104. One non-limiting example of a specialized game execution engine might include hardware and software from a Nintendo GameCube entertainment system that readily supports play of prototype video games being designed for Nintendo's GameBoy Player.

The hard disk drive (HDD) 106 stores the downloaded prototype software received from the client 92 in an encrypted format. The game-specific execution hardware and/or software 104 is able to decrypt the prototype game software on-the-fly during game play. As in FIG. 3, the hard disk 106 is protected by a password based on ATA security which renders the hard drive inaccessible outside of the system shown in FIG. 4.

The above technology provides substantial advantages for testing and evaluating software. The software may be provided cheaply and securely by any suitable electronic means. There is no need for humans to deliver, monitor, and retrieve the software at remote test sites. Control of the software is maintained throughout the delivery, test, and evaluation process by the software developer. Various security features ensure that the software is not compromised or copied during any part of that process.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 U.S.C §112 unless the words “means for” are used.

1. A method for a server to securely deliver software and monitor a client's evaluation of the software over a network, comprising:
encrypting the software using one or more levels of encryption;
transmitting the encrypted software from the server over the network to the client for execution of the software to permit an evaluation of the software at the client;
initially authenticating the client over the network;
if the authentication is positive, authorizing execution of the software at the client;
monitoring the evaluation during the execution of the software at the client;
determining that the evaluation should be halted; and
if the evaluation is determined to be halted, the server prohibiting execution of the software or access to the software at the client.

2. The method in claim 1, further comprising:
starting a check out period associated with when the server transmitted the software over the network to the client;
monitoring the check out period; and
prohibiting further execution of the software or access to the software at the client when the check out period expires.

3. The method in claim 1, wherein the software is prototype software to be tested by a third party different from a developer of the prototype software, and wherein the prohibiting step includes erasing the prototype software from the client machine.

4. The method in claim 1, wherein the software is prototype software to be tested by a third party different from a developer of the prototype software, the method further comprising the server preventing unauthorized use of the prototype software at the client.

5. The method in claim 4, wherein preventing unauthorized use of the prototype software includes the server preventing transmission, copying, or modification of the prototype software at the client.

6. The method in claim 4, wherein the monitoring step includes the server periodically prompting the client to provide the server with some information, and wherein if the client fails to provide the prompted information within a predetermined time period, prohibiting execution of the software or access to the software at the client.

7. The method in claim 1, wherein the initial authentication includes requiring the client to provide the server a correct log-in identifier and a correct password, and wherein if the authentication is positive, the method further comprises authorizing temporary storage of the software at the client.

8. The method in claim 1, wherein multiple different levels of encryption are used by the server to encrypt the software.

9. The method in claim 1, wherein the software is game software, the client is a game software evaluator, and the server is a game software developer remotely located from the game software evaluator.

10. A method for securely evaluating software by a software evaluator, comprising:
electronically receiving from a server the software over a network, the software being encrypted on at least two encryption levels;
decrypting the software at one of the encryption levels;
initially performing an authentication over the network with the server;
if the authentication is positive, decrypting a first portion of the software at the other of the encryption levels and executing of the first software portion to permit evaluation of the first software portion; and
after decrypting the first portion and before execution of the first software portion is completed, decrypting a second portion of the software at the other of the encryption levels and then executing of the second software portion to permit evaluation of the second software portion.

11. The method in claim 10, further comprising:
during the decrypting and executing, receiving over the network multiple prompts from the server, and
responding to the prompts to ensure continued evaluation of the software.

12. The method in claim 10, further comprising:
temporarily storing the software with the other level of encryption if the authentication is positive,
wherein the software is stored in a password-protected hard disk drive that renders contents stored on the hard disk drive inaccessible to the evaluator.

13. The method in claim 10, wherein the software evaluator includes a client for communicating with the server and an execution engine coupled to the client, and wherein the software is stored and executed on the execution engine.

14. The method in claim 10, wherein access to and execution of the software is controlled by the server.

15. The method in claim 14, wherein control signals from the server over the network prevent unauthorized use of the prototype software at or by the evaluator including preventing transmission, copying, or modification of the prototype software.

16. The method in claim 10, wherein the initial authentication includes providing the server with a correct log-in identifier and a correct password.

17. Apparatus for securely delivering software and monitoring an evaluation of the software over a network, comprising electronic circuitry configured to:
encrypt the software using one or more levels of encryption;
transmit the encrypted software from a server over the network to a client for execution of the software to permit an evaluation of the software;
initially authenticate the client over the network;
authorize execution of the software at the client if the authentication is positive;
monitor the evaluation during the execution of the software at the client;
determine that the evaluation should be halted; and
prohibit execution of the software or access to the software at the client.

18. The apparatus in claim 17, wherein the electronic circuitry is further configured to:
start a check out period associated with when the server transmitted the software over the network to the client;
monitor the check out period; and
prohibit further execution of the software or access to the software at the client when the check out period expires.

19. The apparatus in claim 17, wherein:
the software is prototype software to be tested by a third party different from a developer of the prototype software;
the electronic circuitry is further configured to authorize temporary storage of the prototype software at the client after the positive authentication; and
the electronic circuitry is further configured to erase the prototype software from the client machine.

20. The apparatus in claim 17, wherein the software is prototype software to be tested by a third party different from a developer of the prototype software, wherein the electronic circuitry is further configured to prevent unauthorized use of the prototype software at the client.

21. The apparatus in claim 20, wherein the electronic circuitry is further configured to prevent transmission, copying, or modification of the prototype software at the client.

22. The apparatus in claim 20, wherein the electronic circuitry is further configured to periodically prompt the client to provide the server with information, and wherein if the client fails to provide the prompted information within a predetermined time period, the electronic circuitry is further configured to prohibit execution of the software or access to the software at the client.

23. The apparatus in claim 17, wherein the electronic circuitry is further configured to encrypt the software with multiple different levels of encryption.

24. The apparatus in claim 17, wherein the software is game software, the client is a game software evaluator, and the server is a game software developer remotely located from the game software evaluator.

25. Apparatus for securely evaluating software by a software evaluator, comprising electronic circuitry configured to:
electronically receive from a server the software over a network, the software being encrypted on at least two encryption levels;
decrypt the software at one of the encryption levels;
initially perform an authentication over the network with the server;
if the authentication is positive, decrypt a first portion of the software at the other of the encryption levels and execute the first software portion to permit evaluation of the first software portion; and
after decryption of the first portion and before execution of the first software portion is completed, decrypt a second portion of the software at the other of the encryption levels and then execute the second software portion to permit evaluation of the second software portion.

26. The apparatus in claim 25, wherein the electronic processing circuitry is further configured to:
receive over the network multiple prompts from the server during the decrypting and executing, and
respond to the prompts to ensure continued evaluation of the software.

27. The apparatus in claim 25, wherein if the authentication is positive, the electronic processing circuitry is further configured to temporarily store the software in a password-protected hard disk drive that renders contents stored on the hard disk drive inaccessible to the evaluator.

28. The apparatus in claim 25, wherein the electronic circuitry includes a communications routine for communicating with the server and an execution engine for storing and executing the software.

29. The apparatus in claim 25, wherein the electronic processing circuitry is further configured to receive control signals from the server over the network that prevent unauthorized use of the prototype software at or by the apparatus including preventing transmission, copying, or modification of the prototype software.

30. A system securely delivering prototype game software and evaluating the prototype game software over a network, comprising:
a game server including a server processor and a server memory for storing the prototype game software, encryption code, server authentication code, and monitoring code;
a network coupled to the game server;
a game evaluation client coupled to the network including a client processor and a client memory for storing decryption code, client authentication code, and remote access control code;
wherein the encryption code is configured to control the server processor to encrypt the prototype game software using multiple levels of encryption and transmit the encrypted software over the network to the game evaluation client;
wherein the server authentication code is configured to control the server processor to initially authenticate the game evaluation client over the network, and if the authentication is positive, authorize execution of the prototype game software at the game evaluation client;
wherein the server monitoring code is configured to control the server processor to monitor the evaluation at the game evaluation client during the execution of the prototype game software at the client, determine that the evaluation should be halted, and prohibit execution of the prototype game software or access to the prototype game software at the game evaluation client.

31. The system in claim 30, wherein:
the client processor is configured to electronically receive from a server the prototype game software over a network encrypted on at least two encryption levels;
the decryption code is configured to control the client processor to decrypt the software at one of the encryption levels and store the decrypted software;
the client authentication code is configured to control the client processor to initially perform an authentication over the network with the server processor;
if the authentication is positive, the decryption code is configured to control the client processor to decrypt a first portion of the software at the other of the encryption levels so that the client processor can execute the first software portion to permit evaluation of the first software portion; and
after decryption of the first portion and before execution of the first software portion is completed, the decryption code is configured to control the client processor to decrypt a second portion of the software at the other of the encryption levels and so that the client processor can then execute the second software portion to permit evaluation of the second software portion.

32. The system in claim 31, wherein the server processor is configured to prevent unauthorized use of the prototype game software at the game evaluation client.

33. The system in claim 32, wherein the server processor is configured to prevent transmission, copying, or modification of the prototype game software at the game evaluation client.

34. The system in claim 32, wherein the server processor is configured to erase the prototype game software from the game evaluation client.

35. The system in claim 31, wherein the server processor and the client processor are configured to maintain an electronic dialog over the network during the evaluation.
